(19) United States
(12) Patent Application Publication
(10) Pub. No.: US 2024/0034654 A1
(43) Pub. Date: Feb. 1, 2024

(54) METHOD AND APPARATUS FOR THE DESTRUCTION AND DEFLUORINATION OF PER- AND POLYFLUOROALKYL SUBSTANCES (PFAS), FLUOROTELOMERS AND OTHER PERSISITENT ORGANIC POLLUTANTS

(71) Applicant: Claros Technologies Inc., Minneapolis, MN (US)

(72) Inventors: Conor Hogan Broderick, Minneapolis, MN (US); Zijie Xia, Edina, MN (US); Evan Anthony Leslie, Minneapolis, MN (US); John Wilfrid Brockgreitens, Minneapolis, MN (US); Abdennour Abbas, Falcon Heights, MN (US)

(73) Assignee: Claros Technologies Inc., Minneapolis, MN (US)

(21) Appl. No.: 18/212,603

(22) Filed: Oct. 20, 2023

Related U.S. Application Data
(60) Provisional application No. 63/353,879, filed on Jun. 21, 2022.

(51) Int. Cl. C02F 1/72; C02F 1/70; C02F 1/66

(52) U.S. Cl. CPC C02F 1/722; C02F 1/72; C02F 1/70; C02F 1/66; C02F 2101/36

(57) ABSTRACT

The present disclosure generally relates to processes for destruction of persistent and recalcitrant organic pollutants, including PFAS using a combination of oxidative and reductive destruction. The present disclosure also includes treatment systems that apply a UV oxidative process followed by a UV reduction process to the product of the UV oxidation process.

### CROSS-REFERENCE TO RELATED APPLICATIONS

The present application claims the benefit of provisional application No. 63/353,879, filed Jun. 21, 2022, entitled, “Method and Apparatus for the Destruction and Defluorination of Per- and Polyfluoroalkyl Substances (PFAS), Fluorotelomers and Other Persistent Organic Pollutants,” which is hereby incorporated herein by reference in its entirety.

### BACKGROUND

Per- and poly-fluoroalkyl substances (PFASs) are a class of synthetically prepared compounds that have been used for decades in numerous consumer and industrial applications. PFASs have some unique surface properties and can also be both hydrophobic and oleophobic. As a result, PFASs are used as coating aids, lubricants, foaming aids and various surface treatments. They have proven especially useful as flame retardants in the form of aqueous film-forming foams (AFFF). Also, some PFASs are known to bio-accumulate in plants and animals. There is a growing body of evidence that exposure to PFASs can also cause a variety of health problems. Owing to these concerns, various world-wide regulatory agencies have started to establish strict limits to the presence of PFAS in food and water.

PFASs are a class of chemicals that contain perfluoroalkyl or polyfluoroalkyl groups. The definition and classification of per- and polyfluoroalkyl substances (PFASs) has changed over the time. The definition adopted here is the 2021 definition of the Organization for Economic Cooperation and Development (OECD), which expanded their terminology, stating that “PFASs are defined as fluorinated substances that contain at least one fully fluorinated methyl or methylene carbon atom (without any H/Cl/Br/I atom attached to it), i.e. with a few noted exceptions, any chemical with at least a perfluorinated methyl group (—CF3) or a perfluorinated methylene group (—CF2-) is a PFAS.” Some of the most important examples of PFASs include the perfluorosulfonic acids, such as perfluorooctanesulfonic acids (PFOS) and the perfluorocarboxylic acids (PFCAs) like perfluorooctanecarboxylic acid (PFOA). Fluorotelomers are fluorocarbon-based oligomers, or telomers, synthesized by telomerization. Some fluorotelomers and fluorotelomer-based compounds are a source of environmentally persistent perfluorinated carboxylic acids such as PFOA.

The persistence of PFASs, the health issues, and the regulatory landscape have prompted a great deal of research effort to reduce their presence in the environment. Much of the early work was focused on capture, for example from drinking water. However more recently there has been a stronger effort on the destruction of these materials. One of the attributes of PFASs is their resistance towards breaking down in the environment. PFASs are not easily metabolized by organisms, and do not decompose by exposure to visible light or longer wavelength UV irradiation typically found under terrestrial conditions.

The two primary modes of chemically-mediated PFAS destruction are, respectively, oxidation and reduction. Oxidative destruction is defined by the removal of an electron from the target species (i.e. PFAS) followed by degradation, while reductive destruction is defined by the addition of an electron to the target species followed by degradation. Oxidative and reductive destruction of PFAS can be accomplished with a variety of reagents (e.g. persulfate, hydrogen peroxide, nitrates, and other reagents for oxidation; or iodide, sulfite and other reagents for reduction) and input energies (e.g. ultraviolet light or sonication, among others). Due to the immense structural diversity of PFAS as a class, individual target PFAS have differing levels of susceptibility to oxidative or reductive destruction regimes, and a limited number of sequential oxidation/reduction destruction processes have been reported in the past. Accordingly, there is a need for a “one-pot” approach that involves the use of ultraviolet light or sonication as energetic initiators.

### SUMMARY OF THE INVENTION

The present disclosure includes embodiments directed to and including an apparatus for destroying PFASs that includes a reaction chamber containing one or more UV radiation sources, one or more ports for adding an oxidizing species or one or more reducing species, and one or more sensors for measuring one of the following; pH, oxidizing or reducing potential of the solution (ORP sensor), fluoride concentration, UV intensity, electrical conductivity, temperature and pressure.

The present disclosure also includes embodiments directed to and including a process for destroying PFASs, including irradiating a solution containing one or more PFASs with UV radiation, the solution containing the following: one or more sensitizers capable of absorbing UV radiation, one or more bases with a pH greater than 13, and a sulfite ion.

The present disclosure also includes embodiments directed to and including a process for destroying ultra-short chain PFASs, including, irradiating a solution containing one or more ultra-short chain PFASs with UV radiation, the solution comprising, one or more sensitizers capable of absorbing UV radiation, one or more bases such that the pH of the solution is greater than 13, and a sulfite ion.

### BRIEF DESCRIPTION OF THE DRAWINGS

The following drawings are illustrative of embodiments and do not limit the scope of the invention. The drawings are not necessarily to scale and are intended for use in conjunction with the following detailed description. Embodiments of the invention will be described with reference to the drawings, in which like numerals may represent like elements.

FIG. 1 is a graph showing the reductive destruction of pre-oxidized PFAS stock, according to some embodiments of the present disclosure;

FIG. 2 is a box diagram showing the steps of the inventive process according to some embodiments of the present disclosure;

FIG. 3 is cut-away view of a batch or continuous reactor for use with some embodiments of the present disclosure.

FIG. 4 shows the performance of reductive treatment methods alone using aqueous film forming film (AFFF) contaminated waste stream.

FIG. 5 shows the performance of oxidative treatment methods alone using the same aqueous film forming film (AFFF) contaminated waste stream as used in the reductive treatment case shown in FIG. 4.

FIG. 6 shows a one-pot sequential oxidation-reduction treatment process conducted on military wastewater, according to some embodiments of the present disclosure.

FIG. 7 shows the reductive destruction and defluorination of a PFAS -impacted industrial waste stream, according to some embodiments of the present disclosure.

### DETAILED SUMMARY OF THE INVENTION

The use of the term “destruction” herein refers to the breakdown of toxic chemicals or organic pollutants into harmless byproducts.

The term “defluorination” herein refers to the breaking of the C—F bonds in C—F-based chemical compounds such as PFAS or fluorotelomers.

Ultra-short chain PFAS may be any per or polyfluorinated molecule with a chain length of less than or equal to three carbons atoms.

Reductive destruction methods have been shown to have excellent performance for the treatment of perfluorocarboxylic acids and perfluorosulfonic acids like PFOA, PFOS, and their short-chain relatives, as well as perfluoroethers like HFPO-DA. However, reduction does not effectively treat fluorotelomer compounds such as 6:2 FTS.

Conversely, oxidative destruction methods have shown great efficacy for the degradation of fluorotelomers like 6:2 FTS, producing shorter-chain perfluorocarboxylate and perfluorosulfonate PFAS as degradation byproducts, but oxidation lacks the ability to destroy the byproduct short-chain perfluorocarboxylate and perfluorosulfonate compounds it produces. Representative PFAS structures are shown below.

### Chemical Structures of PFOA, PFOS, 6:2 FTS and HFPO-DA

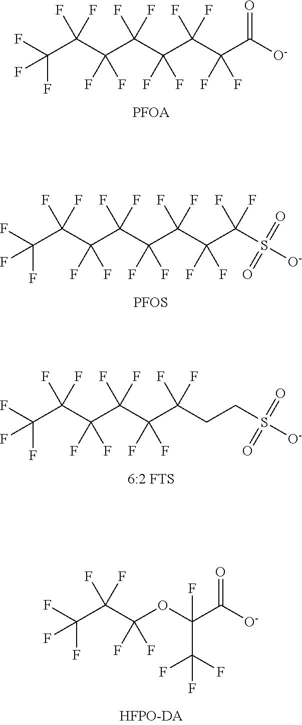

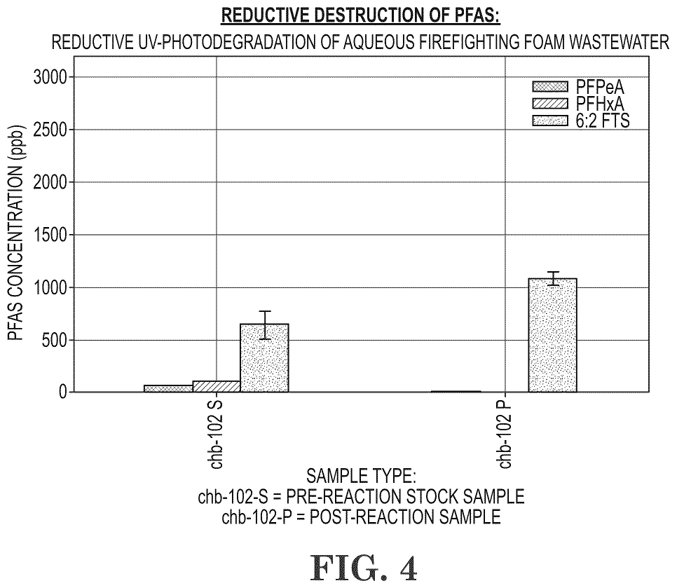

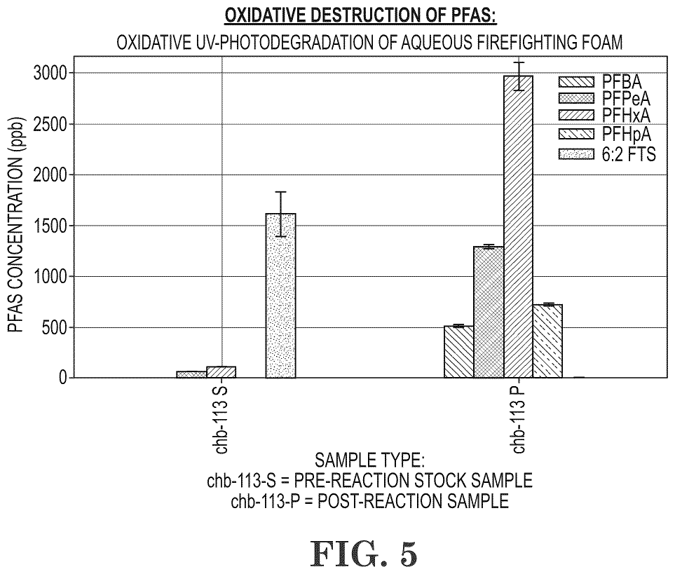

This difference in performance between reductive and oxidative treatment methods is shown below in FIGS. 4 and 5, which show destruction performance testing using the same aqueous film forming foam (AFFF) contaminated waste stream. FIG. 4, the reductive case, exhibits over 95% destruction of PFPeA and PFHxA, the two perfluorocarboxylate compounds in the matrix, but destroys none of the dominant 6:2 FTS fluorotelomer compounds.

In comparison, the oxidative case (shown in FIG. 5) destroys over 90% of the initial 6:2 FTS fluorotelomer, but leaves behind massively increased amounts of the byproduct short-chain carboxylates PFBA, PFPeA, PFHxA, and PFHpA due to degradation of the 6:2 FTS and other undetected pre-oxidation PFAS compounds in the matrix.

Embodiments of the present disclosure improve destruction of PFAS and its byproducts over each of the above approaches. For example, according to the present disclosure, in some embodiments, by combining the oxidative and reductive methods described above in sequence, first oxidizing (as in FIG. 5) and then reducing (as in FIG. 4) the target matrix, complete destruction can be achieved.

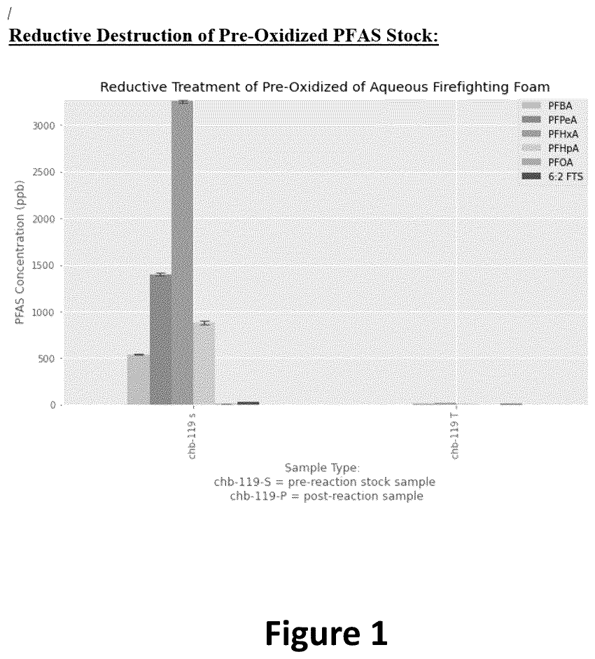

As may be seen in FIG. 1, it has been demonstrated that according to embodiments of this combined, disclosed method, the efficacy of reductive treatment on a PFAS stock which has already been oxidized from its raw form is able to destroy a minimum of 90% and a maximum of 99.99% of the PFAS remaining in solution after pre-oxidation.

According to some embodiments of the present disclosure, a PFAS-impacted matrix such as AFFF-contaminated wastewater may be oxidatively treated, degrading oxidation-sensitive compounds like 6:2 FTS and other fluorotelomers to shorter-chain carboxylates or sulfonates, which are difficult to treat oxidatively. Following the oxidation process, the wastewater may then be subjected to reductive treatment, thereby destroying the remaining carboxylate and sulfonate compounds. This combined treatment according to embodiments of the present disclosure may effectively eliminate all PFAS in the matrix, thereby allowing for safe disposal.

### Example 1

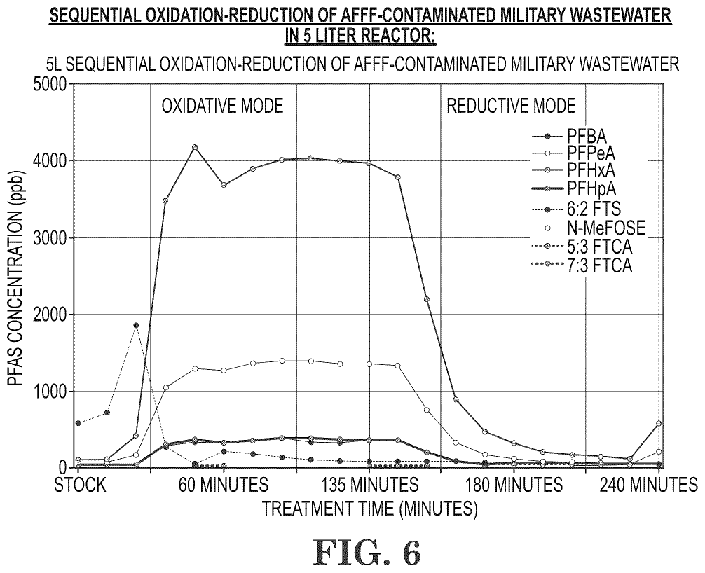

A one-pot sequential oxidation-reduction process at five-liter scale on aqueous film forming foam (AFFF) was conducted on contaminated military wastewater (FIG. 6), which replicated the separated trials shown in FIGS. 4 and 5. The time series shows the same trend of increasing short-chain carboxylate compounds as the 6:2 FTS and other PFAS components oxidatively degrade, followed by swift destruction of the carboxylate compounds when the process is switched to a reductive mode.

According to some embodiments of the present disclosure, PFAS -contaminated wastewater may be treated in the following manner, though it should be understood that embodiments of the present disclosure are not limited to the following: first, oxidizing reagents, including, but not limited to hydrogen peroxide, sodium persulfate, metal nitrate salts (zinc nitrate, nickel nitrate, etc.), or titanium dioxide or other metal, metal-oxide or nonmetal nanoparticles (with nanoparticle size ranging between approximately 1-500 nm), may be added to a PFAS wastewater of a concentration between approximately 0.001 ppt-100,000 ppm. Next, a base may be added to the reaction mixture, including but not limited to hydroxide salts (e.g., sodium hydroxide, calcium hydroxide, ammonium hydroxide, etc.) and carbonate and bicarbonate salts (e.g. sodium bicarbonate),. The base reagent addition may range in concentration from approximately 50 mM to approximately 1M.

Notably, the addition of the base may be done before, during, or after the oxidative treatment. The oxidizing reagent concentrations can range from between about 0.1 mM and about 100 mM; in some embodiments, preferably between 2-10 mM. In some embodiments, the sample may then be irradiated with light of a wavelength of between about 100nm—about 500nm, in some embodiments, preferably about 180—about 300 nm for a time ranging from about 10 min—about 96 hours, in some embodiments, preferably from about 40 min—about 240 min.

Following this oxidative reaction, in some embodiments, the oxidative reagents may be quenched or removed from the solution. Reductive reagents, including but not limited to sodium sulfite, potassium iodide, indole derivatives, and other hydrated-electron generating organic or inorganic reagents or catalysts may then be added to the reaction mixture and irradiated with light of a wavelength between about 150 nm—about 500 nm, in some embodiments preferably between about 200—about 300 nm for a time ranging from about 10 min to about 96 hours, in some embodiments, preferably from about 1 to about 4 hours, destroying all remaining PFAS degradation byproducts of the oxidative reaction in excess of 92%, according to some embodiments. In some embodiments, the reductive reagent concentrations can range between about 0.1 mM and about 200 mM, in some embodiments, preferably between about 2 and about 50 mM.

In some embodiments, reagent additions may be done in bulk at the initialization of the procedure, or throughout the reductive process, for example. In waters significantly impacted by co-contaminants such as nitrate, organic contents, or cationic metal species, for example, higher reagent additions (for example, but not limited to about 200 mM) may be used. This post-treatment matrix, with PFAS removed, may then be safely disposed of.

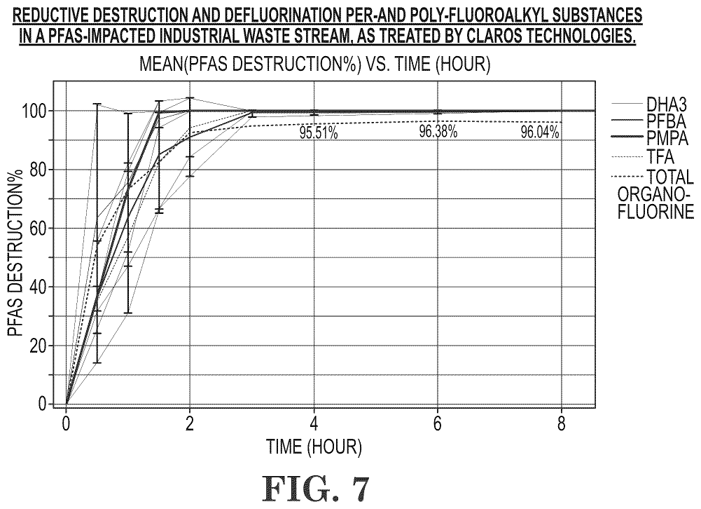

FIG. 7 demonstrates the reductive destruction and defluorination of a PFAS-impacted industrial waste stream including ultra-short chain PFAS, according to embodiments of the present disclosure. Ultra-short chain PFAS may be any per or polyfluorinated molecule with a chain length of less than or equal to three carbons atoms. As seen, the above-described reductive procedure culminates in a significant and impressive 96% reduction in observed Total Organofluorine (TOF) in the PFAS-impacted industrial waste sample, from an initial TOF concentration of 33,114 ppb (μg/L).

Table 1 provides results obtained form the treatment of AFFF wastewater from a military site using a 5 liter reactor, according to Example 1. As may be seen, treatment for 2-4 hours results in a 92-100% destruction of all PFAS compounds in a single pass.

TABLE 1

| PFAS | Initial | Final | Percent |
|---|---|---|---|
| Compound | Concentration | Concentration | Destroyed |
| 6:2 FtTAos | −3000 ppb | N/D | 100% |
| 6:2 FTS | 638 ppb | 50 ppb | 92% |
| PFBA | 369 ppb | 27 ppb | 93% |
| PFPeA | 1350 ppb | 51 ppb | 96% |
| PFHxA | 3967 ppb | 124 ppb | 97% |
| PFHpA | 368 ppb | 15 ppb | 96% |

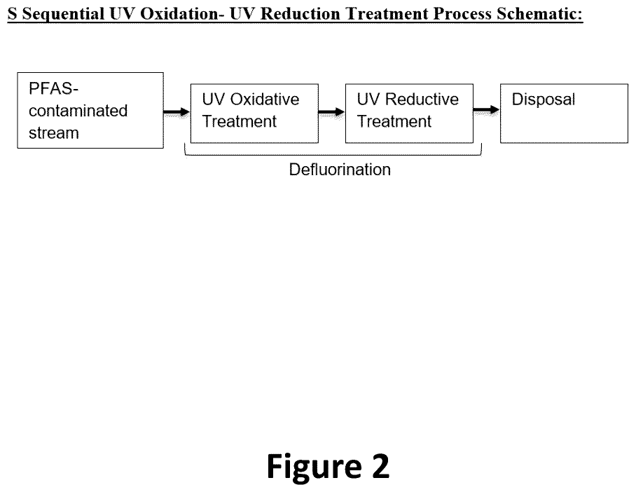

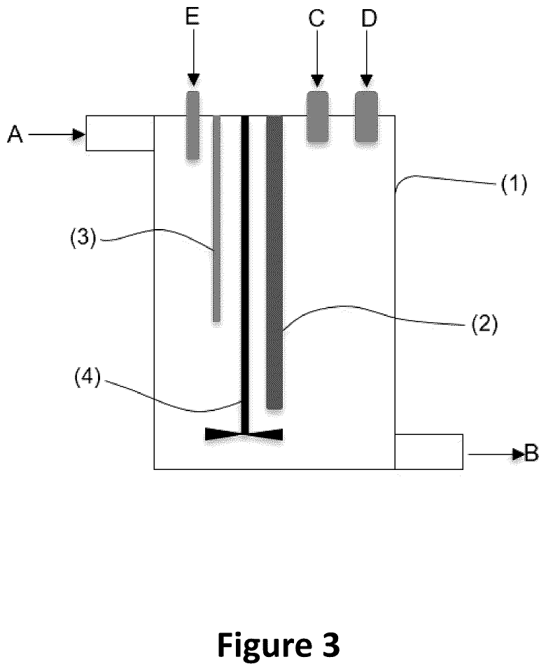

FIG. 2 shows the major steps involved in the combined oxidative-reductive treatment, according to some embodiments of the present disclosure. FIG. 3 shows an example of a batch or continuous reactor that may be used to conduct the sequential UV oxidative-reductive treatment of PFAS contaminated streams (water, wastewater, AFFF), according to some embodiments of the present disclosure. As may be seen, the treatment may take place in a batch or continuous reactor as shown in FIG. 3. They system includes, an opaque reactor tank or vessel made from or other materials (1); one or more UV lamp(s) emitting in the wavelength range of about 100—about 500 nm (2); an optional pH sensor (3); and an agitation system (4), including, but not limited to, an impeller, mixer and/or stirrer for the homogenization of solutions or reagents. Further, the system may have an inlet (A) for PFAS concentrate solution or PFAS-contaminated stream; effluent (B); oxidative reagent intake (C); reductive reagent intake (D); and an acid/base intake for pH control (E). It is to be appreciated that the positioning of the components of the system may be different than those shown.

The inventive process disclosed herein may also be applied to other persistent organic pollutants, including, but not limited to: aldrin, chlordane, DDT, dieldrin, endrin, heptachlor, hexachlorobenzene, mirex, polychlorinated biphenyls, polychlorinated dibenzo-p-dioxins, polychlorinated dibenzofurans, and toxaphene, for example.

Similarly, the inventive process disclosed herein may be applied to other recalcitrant water pollutants, including, but not limited to: 3,4,3′4′-tetrachlorobiphenyl 2,4,5,2′4,5′-hexachlorobiphenyl, 2,3,7,8-tetrachloro-dibenzo[p]dioxin (TCDD), 1,1,1-trichloro-2,2-bis(4-chlorophenyl)-ethane (DDT), 1,C,3,4,5,6-hexachlorocyclohexane (Lindane) and benzo[a]pyrene, Chlordane, 2,2,2-trichloro-1,1-bis(4chlorophenyl)ethanol (dicofol), pentachlorophenol, Aroclor-1254, phenanthrene, biphenyl p-cresol and 2-methylnaphthalene, for example.

Embodiments of the present disclosure provide numerous advantages. As described herein, some embodiments of the present disclosure may use UV-based oxidation followed by UV-based reduction. Such embodiments therefore use UV in both steps and can take place at around ambient temperature (no heat added beyond that generated by the UV lamp). The result is very high levels of destruction of fluorotelomers up to 100%, and destruction of other PFAS at 92-97%. It also allows for both steps of the process to be performed in a single reactor because both are based on UV photochemistry. In addition, embodiments of the present disclosure may only require the input of reagents twice; (1) at the beginning of oxidation and (2) then at the beginning of reduction, and may be performed without a continuous introduction of reagents during the process. Furthermore, the process may be performed quickly, such as in about 1-4 hours or less. Finally, the process requires less energy input by avoiding the use of high temperatures required for prior art thermal oxidation processes.

Embodiments of the present disclosure may also include an apparatus for destroying PFASs comprised of the following elements: 1) a reaction chamber containing one or more UV radiation sources, 2) one or more ports for adding an oxidizing species or one or more reducing species, 3) optionally, equipped with one or more sensors capable of measuring one of the following: pH; oxidizing or reducing potential of the solution (ORP sensor); fluoride concentration; UV intensity; electrical conductivity; temperature and pressure; 4) optionally, a thermal jacket surrounding at least a portion of the reaction chamber which can be cooled or heated with a fluid.

Embodiments of the present disclosure may also include an apparatus for destroying PFASs including a thermal jacket surrounding at least a portion of the reactor.

Embodiments of the present disclosure may also include an apparatus for destroying PFASs equipped with one or more sensors capable of measuring one or more of the following: pH; oxidizing or reducing potential of the solution (ORP sensor); fluoride concentration; UV intensity; electrical conductivity; temperature and pressure.

Embodiments of the present disclosure may also include an apparatus for destroying PFASs equipped with one or more sensors capable of measuring one or more of the following: pH; oxidizing or reducing potential of the solution (ORP sensor); fluoride concentration; UV intensity; electrical conductivity; temperature and pressure; and a thermal jacket surrounding at least a portion of the reactor.

Embodiments of the present disclosure may also include an apparatus for destroying PFASs whereby the UV radiation source is one or more low pressure mercury lamps.

Embodiments of the present disclosure may also include an apparatus containing one or more sensors capable of measuring all of the following: pH; oxidizing or reducing potential of the solution (ORP sensor); fluoride concentration; UV intensity; electrical conductivity; temperature and pressure.

Embodiments of the present disclosure may also include a process for destroying PFASs which consists of irradiating a solution containing one or more PFASs with UV radiation, the solution containing the following: 1) one or more sensitizers capable of absorbing UV radiation; 2) one or more strong bases such that the pH of the solution is >13; and/or 3) optionally, the sulfite ion.

Embodiments of the present disclosure may also include a process for destroying PFASs which consists of irradiating a solution containing one or more PFASs with UV radiation containing the sulfite ion.

Embodiments of the present disclosure may also include for destroying PFASs wherein one or more strong bases is an alkali metal hydroxide such that the pH of the solution is >13.

Embodiments of the present disclosure may also include a process for destroying PFASs wherein one or more strong bases is sodium hydroxide such that the pH of the solution is >13.

Embodiments of the present disclosure may also include a process for destroying PFASs wherein one or more strong bases is potassium hydroxide such that the pH of the solution is >13.

Embodiments of the present disclosure may also include a process for destroying PFASs which consists of irradiating a solution containing a sulfite ion wherein the sulfite species is a sodium salt of sulfite.

Embodiments of the present disclosure may also include a process for destroying PFASs which consists of irradiating a solution containing a sulfite ion wherein the sulfite species is a potassium salt of sulfite.

Embodiments of the present disclosure may also include a process for destroying PFASs wherein one or more strong bases is a mixture of sodium hydroxide and sodium carbonate such that the pH of the solution is >13.

Embodiments of the present disclosure may also include a process wherein the sensitizer capable of absorbing UV radiation is sodium or potassium iodide.

Embodiments of the present disclosure may also include a process wherein one or more strong bases is added such that the pH of the solution is >13.2.

Embodiments of the present disclosure may also include a process for destroying PFASs which consists of irradiating a solution containing a sulfite ion at a concentration of 5 mM to 500 mM sodium iodide and 50 mM to 1M sodium sulfite.

Embodiments of the present disclosure may also include a process wherein the sensitizer capable of absorbing UV radiation is present at a concentration of 5 mM to 500 mM.

Embodiments of the present disclosure may also include a process for destroying ultra-short chain PFASs which consists of irradiating a solution containing one or more PFASs with UV radiation, the solution containing the following: 1) one or more sensitizers capable of absorbing UV radiation; 2) one or more strong bases such that the pH of the solution is >13; and/or 3) optionally, the sulfite ion.

Embodiments of the present disclosure may also include a process for destroying PFASs which consists of irradiating a solution containing one or more PFASs with UV radiation containing the sulfite ion.

Embodiments of the present disclosure may also include a process for destroying PFASs wherein one or more strong bases is an alkali metal hydroxide such that the pH of the solution is >13.

Embodiments of the present disclosure may also include a process for destroying PFASs wherein one or more strong bases is sodium hydroxide such that the pH of the solution is >13.

Embodiments of the present disclosure may also include a process for destroying PFASs wherein one or more strong bases is potassium hydroxide such that the pH of the solution is >13.

Embodiments of the present disclosure may also include a process for destroying PFASs which consists of irradiating a solution containing a sulfite ion wherein the sulfite species is a sodium salt of sulfite.

Embodiments of the present disclosure may also include a process for destroying PFASs which consists of irradiating a solution containing a sulfite ion wherein the sulfite species is a potassium salt of sulfite.

Embodiments of the present disclosure may also include a process for destroying PFASs wherein one or more strong bases is a mixture of sodium hydroxide and sodium carbonate such that the pH of the solution is >13.

Embodiments of the present disclosure may also include a process wherein the sensitizer capable of absorbing UV radiation is sodium or potassium iodide.

Embodiments of the present disclosure may also include a process wherein one or more strong bases is added such that the pH of the solution is >13.2.

Embodiments of the present disclosure may also include a process for destroying PFASs which consists of irradiating a solution containing a sulfite ion at a concentration of 5 mM to 500 mM sodium iodide and 50 mM to 1M sodium sulfite.

Embodiments of the present disclosure may also include a process wherein the sensitizer capable of absorbing UV radiation is present at a concentration of 5 mM to 500 mM.

Embodiments of the present disclosure may also include a process wherein the PFASs destroyed include trifluoroacetic acid (TFA), perfluoropropionic acid (PFPrA), perfluoro-2-methoxy propanoic acid (PMPA) or their conjugate bases.

Embodiments of the present disclosure may also include a process for the destruction and defluorination of PFAS in water streams (wastewater, runoff water, AFFF, PFAS concentrates resulting from water treatment systems) comprising applying a UV oxidation process to the PFAS to produce a product and then applying a UV reduction process to the product of the UV oxidation process.

Embodiments of the present disclosure may also include a process for the destruction of persistent and recalcitrant organic pollutants other than PFAS in water streams (wastewater, runoff water, AFFF, PFAS concentrates resulting from water treatment systems) comprising applying a UV oxidation process to the pollutants to produce a product and then applying a UV reduction process to the product of the UV oxidation process.

It shall be understood that the present disclosure is not limited to specific embodiments disclosed, but rather includes all combinations of various elements disclosed and any known or later arising variants thereof.

What is claimed is:

1. An apparatus for destroying PFASs comprising:
a reaction chamber containing one or more UV radiation sources;
one or more ports for adding an oxidizing species or one or more reducing species; and
one or more sensors for measuring one of the following: pH, oxidizing or reducing potential of the solution (ORP sensor), fluoride concentration, UV intensity, electrical conductivity, temperature and pressure.

2. The apparatus of claim 1, further comprising a thermal jacket surrounding at least a portion of the reaction chamber, wherein the thermal jacket is fillable with a heating or colling fluid.

3. The apparatus of claim 1, wherein at least one of the UV radiation sources is a low pressure mercury lamp.

4. A process for destroying PFASs , comprising: irradiating a solution containing one or more PFASs with UV radiation, the solution containing the following: one or more sensitizers capable of absorbing UV radiation, one or more bases with a pH greater than 13, and a sulfite ion.

5. The process of claim 4, wherein the solution includes the sulfite ion.

6. The process of claim 4, wherein the base is an alkali metal hydroxide.

7. The process of claim 4, wherein the base is potassium hydroxide.

8. The process of claim 5, wherein the sulfite species is a sodium salt of sulfite.

9. The process of claim 5, wherein the sulfite species is a potassium salt of sulfite.

10. The process of claim 4, wherein the base includes a mixture of sodium hydroxide and sodium carbonate.

11. The process of claim 4, wherein the sensitizer capable of absorbing UV radiation sodium or potassium iodide.

12. The process of claim 4, wherein the base is added in an amount sufficient to establish the pH of the solution at greater than 13.2.

13. A process for destroying ultra-short chain PFASs, comprising:
irradiating a solution containing one or more ultra-short chain PFASs with UV radiation, the solution comprising, one or more sensitizers capable of absorbing UV radiation, one or more bases such that the pH of the solution is greater than 13, and a sulfite ion.

14. The process of claim 13, wherein the PFASs destroyed include trifluoroacetic acid (TFA), perfluoropropionic acid (PFPrA), perfluoro-2-methoxy propanoic acid (PMPA) or their conjugate bases.

15. The process of claim 13, wherein the one or more bases is an alkali metal hydroxide.

16. The process of claim 13, wherein the one or more bases is potassium hydroxide.

17. The process of claim 13, wherein the sulfite ion species is a sodium salt of sulfite.

18. The process of claim 13, wherein the sulfite ion species is a potassium salt of sulfite.

19. The process of claim 13, wherein the sensitizer capable of absorbing UV radiation is sodium or potassium iodide.

20. The process of claim 13, wherein the one or more bases is added in an amount sufficient to establish the pH of the solution at greater than 13.2.
